(19) United States
(12) Patent Application Publication
(10) Pub. No.: US 2004/0195264 A1
(43) Pub. Date: Oct. 7, 2004

(54) Proportional liquid-mixing system

(76) Inventor: Clarence W. Mastbrook JR., Lemita, CA (US)

Correspondence Address: C.W. MASTBROOK Jr., 2135 255th ST., Lemita, CA, 90717, US

(21) Appl. No.: 10/407,877

(22) Filed: Apr. 4, 2003

(51) Int. Cl. B67D 5/08

(52) U.S. Cl. 222/64

(57) ABSTRACT

A proportional liquid-mixing system includes a first container having a magnetic float supported therein. The float is supported by a guide, allowing the liquid levels in the float tube and the container to coincide. A transparent tube affixed outside the vessel contains a visible smaller magnet which is in close magnetic proximity of the first magnet When the first magnet floats, the smaller magnet follows it in proportion to the level of liquid in the container. A proportional reservoir is supported in proximity to the visual indicator and includes apparatus for accumulating a quantity of liquid for dispensing into the first container. The volume and cross-sectional area characteristics of the first container and proportional reservoir are selected to provide proportional volume verses depth characteristics in each liquid.

### CROSS-REFERENCE TO RELATED APPLICATIONS

This application discloses apparatus described in a provisional patent application serial No. 60/300,945 filed Jun. 26, 2001 and entitled PROPORTIONAL LIQUID MIXING SYSTEM, HAVING AN EXCHANGEABLE PROPORTIONAL CONCENTRATE VESSEL which was filed by the Applicant of the present application.

### FIELD OF THE INVENTION

This invention relates generally to proportional mixing of liquids and particularly to apparatus used therein,

### BACKGROUND OF THE INVENTION

Proportional mixing of liquid chemicals is well known and common place in many industries throughout the art. Examples of proportional mixing are found in cleaning and maintenance systems such as floor care or the like, gardening or pest control, sanitation and the like. In addition, proportional mixing of liquid chemicals is also utilized in formulating the gasoline and lubricating oil mixture consumed by two cycle or two stroke internal combustion engines. While the foregoing examples are common place within various industries and pervasive throughout the art, additional virtually endless numbers of highly specialized proportional chemical mixing takes place throughout industry and commerce.

Each of the above referenced proportional mixing systems encounters problems and needs which are more or less specific to the host system. However, all proportional mixing systems share the common problem and challenge associated with the need for reliable, accurate and repeatable proportional volume mixing of liquids.

In certain industries, the primary concern in seeking accuracy of proportional liquid mixing is found in simple economics. That is to say, the avoidance of excessive use of expensive chemicals such as concentrates or detergents.

In other industries, greater concerns such as safety or effectiveness also arise. For example, cleaning and maintenance typically utilize concentrated detergents which are mixed proportionally with water for generally cleaning such as floor care. Most cleaning services employ simple mop and bucket apparatus for floor cleaning. Such apparatus is well known in the art and has been used for many years. While variations of apparatus exists, generally all utilize a quantity of water placed within a mop bucket within which a concentrated detergent solution is utilized. While this mixing of water and concentrate may be accomplished by simple hand measuring, pouring and mixing, most cleaning supply companies provided so-called “filling stations” near a convenient water supply such as a janitors closet within the host facility. Typically, the chemical supplier installs and maintains wall mounted apparatus for dispensing proportionate volumes of water and concentrate to be used by floor cleaning staff, The apparatus is usually based upon an eduction process directed toward proportionate mixing of concentrate and water which is deposited into the mop bucket. The use of one or more filling stations within suitable areas such as janitors closets or the like necessitates that the cleaning staff must return to a filling station each time the need arises to replenish or replace the cleaning solution within the mop bucket. In large areas such as shopping malls, office buildings or factories, this is often an inefficient and time wasting process. Since rentable space in facilities such as malls and office buildings must be maximized for economic gain, provision of ample “decentralized” janitor facilities is impracticable. As a result, cleaning efficiently and cost effectiveness is sacrificed in facility construction rather than reduce rentable income producing space.

Similar problems arises in food service industries and health care facilities such as food stores or hospitals. In addition to cost and efficiency problems however, such facilities have additional concerns such as safety and sanitation.

Hospitals and food service facilities must clean and sanitize floors virtually constantly to meet health and food regulations. This means cleaning solution can not be “stretched” by cleaning staff attempting to cut corners and avoid replacing dirty or contaminated solutions as required. Effective sanitation requires more frequent cleaning and solution changes.

Attempts by practitioners in the art to avoid the use of centralized filling stations often leads practitioners to utilize so-called portable proportional filling systems. The basic concept is sound, that is to provide the cleaning staff for measuring and mixing proportionate concentrates at any convenient water source, The objective is to overcome the inefficiency of filling stations centralization. However, the use of such portable system creates more problems than it solves. Primarily, portable mixing systems use eduction techniques. These systems require high pressure hoses in order to cause the siphoning of the concentrate. These devices still require expensive preventive maintenance. The hoses rupture, minerals contained in the water supply will clog the input opening, etc. The chemical suppliers spend millions per year in order to maintain these and the stationary devices, concentrates is very costly to system operators.

Many liquid mixing systems are also subject to further concerns beyond cost and efficiency which are related to environmental impact of the chemicals used. For example, pest control sprayer systems must be strictly and accurately controlled as to the amount of chemical dispersed in the spraying process. While a variety of chemical sprayers are available for pest control operations, the majority comprise hand carried tank-type sprayers having a reservoir filled with chemical mixture and the apparatus for pumping and pressurizing the tank. An elongated hose with a spray valve and nozzle is coupled to the tank allowing the operator to dispense the spray chemicals. In such systems, inaccurate proportioning of chemicals is simply unacceptable and is often illegal. Pest control operators for example must maintain accurate records of the amount of chemical sprayed at each location serviced. Obviously, without accurate proportional mixing of the chemicals such accurate records can not be maintained.

Another environmentally sensitive type of proportional mixing occurs in the formulation of fuel and lubricating oil mixture for use by two stroke or two cycle internal combustion engines. Such engines are favored by small tool designers and manufactures due to the substantial power produced for a given engine size. An important operating characteristic of two stroke or two cycle internal combustion engines is found in their use of a mixture of gasoline and lubricating oil rather than maintenance of separate fuel and lubricating apparatus. Thus, a quantity of lubricating oil is combined with the gasoline to form the oil mixture used in two stroke or two cycle internal combustion engines. As the engine runs, the circulation and consumption of the lubricating oil and fuel mixture provides lubrication to moving parts.

While two stroke or two cycle internal combustion engines are sometimes used for transportation purposes such as motorcycles or the like, there most pervasive use is found in small portable tools such as cutters, mowers and the like. Needless to say, the efficient operation and environmental needs surrounding the use of such engines requires accurate proportioning of the fuel and lubricating oil used therein. Unfortunately, accurate reliable and easy to use liquid mixing apparatus for uses such as two stroke engines has not been available.

Not surprisingly, the long felt arid persistent need in the art for effective, efficient and accurate proportional liquid mixing systems has prompted practitioners in the art to develop a variety of systems. One of the most common types of proportional liquid mixing systems developed is represented in U.S. Pat. Nos. 5,522,419; 5,253,677 and 6,105,633 all of which employ an eduction or aspiration device to proportionately supply concentrate and base liquid such as water to a mixing vessel. Eduction or siphoning systems have enjoyed some popularity in the art. However, the systems tend to be expensive arid must be installed by trained personnel. When a metering device requires changing, a trained maintenance person must travel to the site and perform the task. In addition, such system are subject to difficulties as the concentrate and mineral deposits from water tend to clog the precisely sized liquid passages. As a result, eduction or siphoning systems tend to require substantial maintenance. In addition, accuracy is often compromised due to variations of water temperature arid concentrate viscosity as well as other perimeters such as pressure at the operative location.

Additional systems intended to supply so-called portable operation include manual measuring cups for measuring the proportionate liquids to be combined. However, this is not truly proportional and is often misused or compromised by less than skilled personnel. Practitioners have also attempted to utilize packets in which a group of packets of a given pre-measured size is supplied to be combined in the mixture process. Of necessity, such packets are more expensive than bulk liquid and often resort to powered constituents to facilitate use. Powered components often provide a safety problem.

Additionally, the manufacturing of both the sprayers and the gasoline storage cans, result in opaque vessels. The user is not able to discern exactly how much primary liquid is in the container. The generally results in an inaccurate mixture. The industry has made many attempts to product, at least, translucent vessels, without solving the problem.

While the foregoing described prior art apparatus and systems have to some extend improved the art and in some instance enjoyed commercial success, there remains nonetheless a continuing need in the art for an evermore improved proportional liquid mixing system which overcomes the discrepancies, shortcomings and problems of the prior art systems.

### SUMMARY OF THE INVENTION

Accordingly, it is a general object of the present invention to provide an improved proportional liquid mixing system for OPAQUE VESSELS. It is more particular object of the present invention to provide an improved proportional liquid mixing system which avoids the need for centralized filling station operation and may be operated at any convenient water or chemical supply location. It is still further object of the present invention to provide an improved proportional liquid mixing system which utilizes a minimum of operator skill and motivation and which maintains accurate proportional component quantities regardless of the quantity of mixture to be made at any given time.

In accordance with the present invention there is provided a proportional liquid-mixing system comprising: a first liquid container receiving a first volume of first liquid and establishing a first liquid level therein; a second liquid container receiving a second volume of a second liquid, the second liquid container defining a cross-sectional area which is related to a predetermined mixing ratio between the first and second liquids; a level indicator responsive to the first liquid level for indicating the level of the second liquid within the second liquid container to establish a second volume related to the first volume of the first liquid in accordance with the mixing ration; and means for combining the first and second volumes. (See attached drawing for confirmation of theory of operation.

In another respect, the present invention provides a proportional liquid-mixing system comprising: a first liquid container having a first liquid volume defining a first liquid level; a second liquid container for receiving a second liquid volume to define a second liquid level; liquid level indication means having a level indicator proximate the second liquid container positioning the level indicator in response to the first liquid level; means for filing the second liquid container with the second liquid to establish a second liquid level generally aligned with the position of the level indicator; and means for transferring the second liquid to the first container.

### BRIEF DESCRIPTION OF THE DRAWINGS

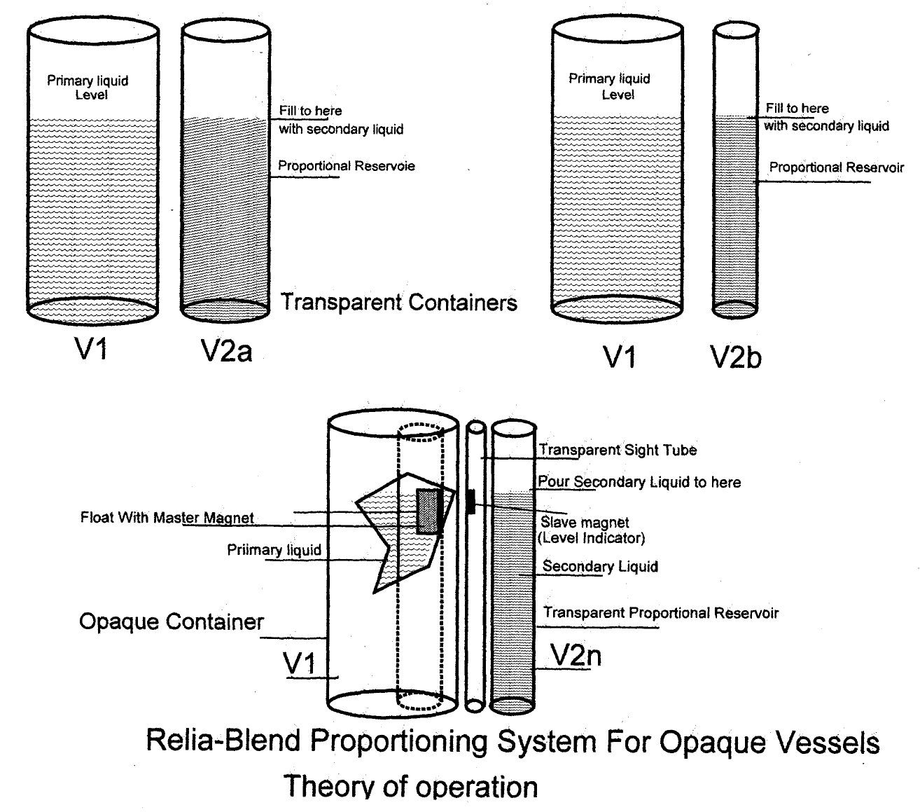

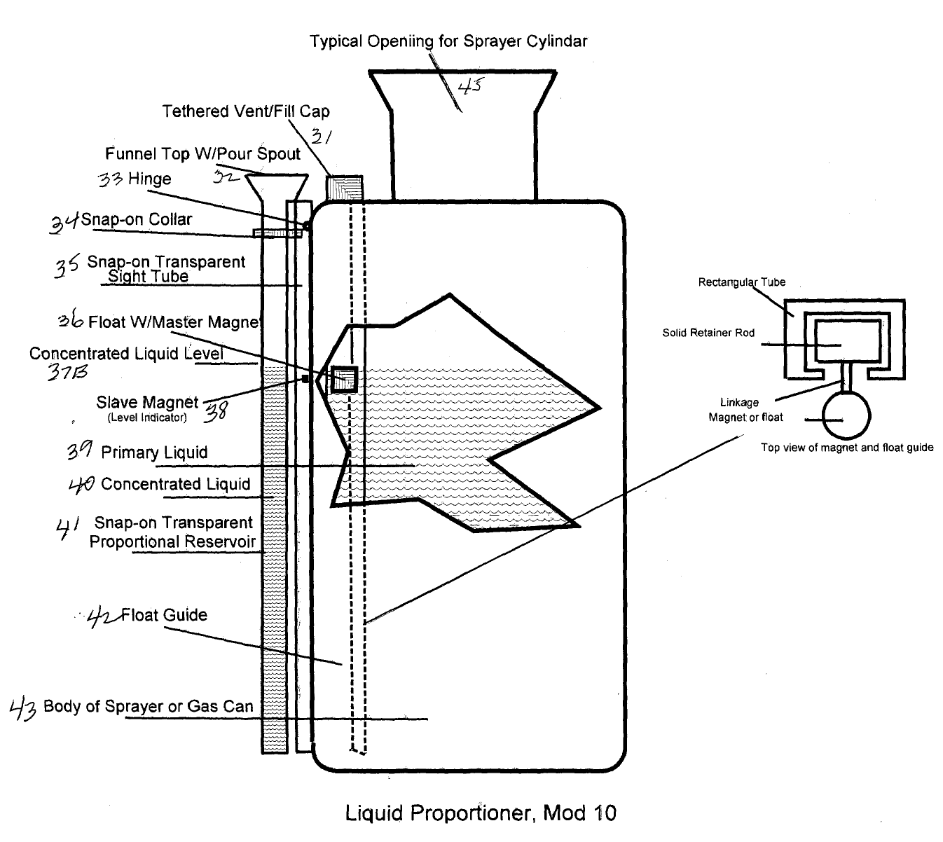

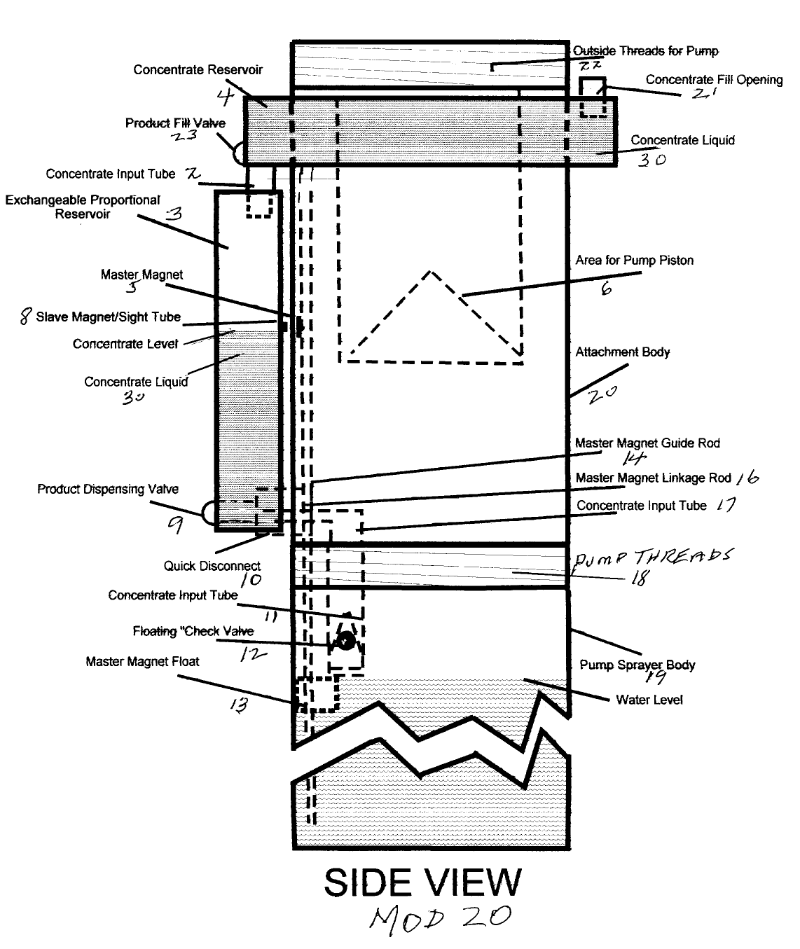

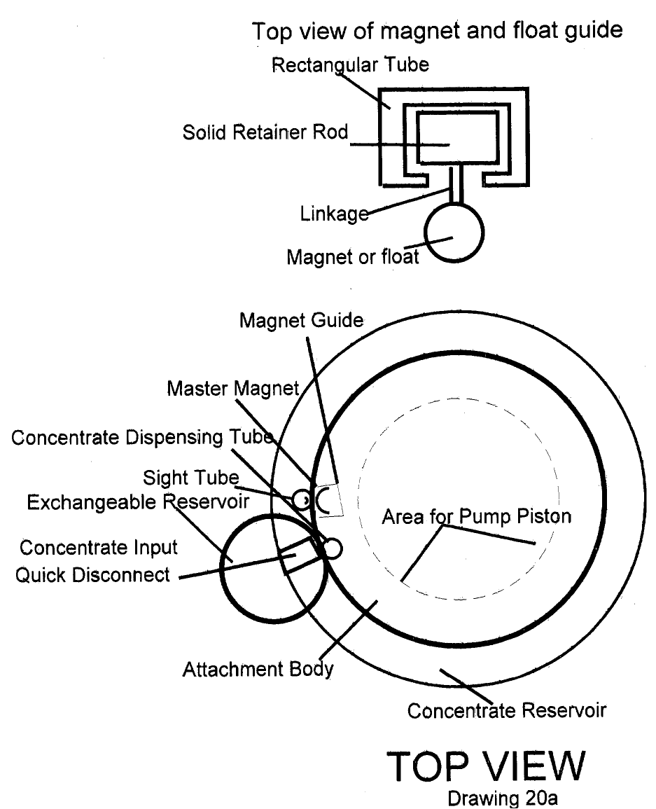

The features of the present invention, which are believed to be novel, are set forth with particularity in the appended claims. The invention, together with further objects and advantages thereof may best be understood by reference to the following description taken in conjunction with the accompanying drawings, in the several figures of which like reference numerals identify like elements and in which: FIG. 10 sets forth a front view of the plastic pump sprayer or gasoline can. FIGS. 20 and 20a set forth views of the advanced version for larger plastic or metal pump sprayers.

### DESCRIPTION OF THE PREFERRED EMBODIMENTS

FIG. 10 sets forth a front view of an opaque vessel which generally will be a pump sprayer or gasoline storage can. In this embodiment, the vessel contains a float containing a master magnet, 36, a guide, 42, a transparent sight tube, 35, attached outside and in close proximity to the master magnet vertical track, a slave magnet, 38, inside the sight tube, and in opposite magnetic pole to the master magnet, a snap-on, exchangeable, proportional reservoir, 41, a hinge, 33 and a tethered vent/fill cap, 31.

The vessel, 46, is filled with the primary liquid, 37a, until the desired level is reached. The float and master magnet, 36, will move upward, kept on a vertical track by the float guide, 42. The magnetic attraction from the master magnet will cause the slave magnet, 38, to move upward in relation to the primary liquid level, 37a. When the desired level is reached, the magnets will stop moving. The transparent proportional reservoir, 41, can be viewed in relation to the level of the slave magnet. The concentrated liquid is then poured into the proportional reservoir until it reaches the level indicated. The tethered vent/fill cap, 31, is removed and the reservoir is tilted upward to fill the vessel with the concentrate. The cap is replaced and the vessel is now ready to use. When a new ratio is required, the user simply attaches another appropriate proportional reservoir to the unit.

System 20: System 10 will not operate with a metal pump sprayer since the metal will interfere with the magnet system. System 20 is based on the “wide mouth” version of pump sprayer, presently manufactured by several sprayer companies. These are manufactured in both metal and plastic. This embodiment will attach to these devices with no modification. Since it extends the length of the unit, it would probably be outfitted with a wheeled cart.

The proportional attachment, 20, is attached to the sprayer body, 19, by first removing the threaded pump attachment. The bottom threads of the attachment match the outside threads of the sprayer, 18. The attachment consists of a plastic, cylindrically shaped body, 20, a female quick disconnect, 10, a circular shaped concentrate reservoir, 4, a float and master magnet guide rod, 14, a float, 13, a concentrate input tube, 11, a check valve, 12, and a spring biased product fill valve, 23, a transparent, replaceable sight tube, 1, containing the slave magnet, 24, is attached in close magnetic proximity to the master magnet inside the vessel.

Each exchangeable proportional reservoir, 8, is equipped with a horizontally situated male quick disconnect member, insertable into the female quick disconnect, 10, on the sprayer body. Another male quick disconnect member, 30, is situated vertically at the top of the reservoir for insertion into the female quick disconnect attached to the concentrate container, 2.

When the sprayer, 19, is filled with water, the float, 13, will move upward, causing the linkage, 16, to push the master magnet, 5, upward. This, in turn will cause the slave magnet, 24, to move upward in the same manner. When the desired water level is reached, the operator may observe the level of the water by observing the slave magnet, 24, in close proximity to the proportional reservoir, 8. The operator will then depress the product fill valve, 23, until the concentrate liquid reaches the level of the slave magnet indicator, 24. Then the product dispensing valve, 9, is depressed until all of the concentrate is dispensed into the pump sprayer.

The pump cylinder is then screwed into the top of the attachment, 22, and pumped to the desired pressure. The floating check valve, 12, prevents pressurized liquid from re-entering the proportional reservoir. When another concentrate and/or another ratio is required, both or either of the concentrate or proportional vessels can be easily changed out. This embodiment will save time for the user, since the product is carried with the unit.

Some state government environmental protection agencies require commercial pesticide applicators to report the amount of pesticide dispensed at each site. At present it is estimated only. By affixing an appropriate indicator beside the sight tube, an applicator can easily show the exact amount dispensed at each job site.

While particular embodiments of the invention have been shown and described, it will be obvious to those skilled in the art that changes and modification may be made without departing from the invention in its broader aspects. Therefore, the aim of the appended claims is to cover such changes and the modifications as fall within the true spirit and scope of the invention.

That which is claimed is:

1. A proportional liquid-mixing system comprising:
a first liquid container receiving a first volume of first liquid establishing a first liquid level therein;
a second liquid container receiving a second volume of a second liquid, said second liquid contiaer defining a cross-sectional area which is related to a predetermined mixing ratio between said first and second liquids;
a magnetic level indicator responsive to said first liquid level for indicating the level of second liquid within said second liquid container to establish a second volume related to the first volume of said first liquid in accordance with said mixing ratio;
and means for combining said first and second volumes.

2 A proportional liquid mixing system comprising:
a first liquid container having a first liquid volume defining a first liquid level; a second liquid container for receiveing a xecond liquid volume to define a scecond liquid level; liquid lefel indication means having a magnetic level indicator proximate said second liquid container positioning said magnetic level indicator in response to said first liquid level; and means for filling second liquid container with said second liquid to establish a second liquid level generally aligned with said position of said magnetic level indicator; and means for transferring said second liquid to said first container.

3. The proportional liquid mixing system set forth in claim 2, wherin said first and second containers define respective first and second cross sectional areas related by a desired proportion.
